(19) United States
(12) Patent Application Publication
(10) Pub. No.: US 2025/0268276 A1
(43) Pub. Date: Aug. 28, 2025

(54) MANUFACTURING DEVICE FOR COMPRESSED COFFEE BEAN BLOCK

(71) Applicant: John H. Koh, Goyang-si (KR)

(72) Inventor: John H. Koh, Goyang-si (KR)

(21) Appl. No.: 18/959,210

(22) Filed: Nov. 25, 2024

Related U.S. Application Data
(63) Continuation-in-part of application No. 18/586,261, filed on Feb. 23, 2024, now Pat. No. 12,161,133.

(51) Int. Cl. A23F 5/38; A23P 10/28

(52) U.S. Cl. CPC A23F 5/385; A23P 10/28

(57) ABSTRACT

A compressed coffee bean block manufacturing apparatus can include a main unit; a supply unit providing coffee beans to a supply area located within the main unit; a storage unit that receives the coffee beans in a storage space device from the supply area and transports the coffee beans to a compression area on one side of the supply area; and a compression and discharge unit that compresses and shapes the coffee beans in the compression area into a coffee bean block and then transports the coffee bean block to a discharge area on one side of the compression area for ejection, wherein the supply unit compresses or cracks the coffee beans before providing the coffee beans to the supply area.

### CROSS REFERENCE TO RELATED APPLICATION

This application is a Continuation-In-Part Application of U.S. patent application Ser. No. 18/586,261, filed on Feb. 23, 2024, the entire content of which is hereby expressly incorporated by reference into the present application.

### BACKGROUND OF THE INVENTION

### Field of the Invention

Embodiments of the present disclosure relate to a method of manufacturing a coffee bean block containing coffee particles, and to a compressed coffee bean block manufacturing device that compresses whole roasted coffee beans directly, without a grinding process, to form coffee bean blocks by compression. The coffee bean block is used to prepare coffee drinks that allow people to enjoy a uniquely deep and rich flavors of roasted coffee with ease by providing a pre-measured amount of coffee to be brewed with convenience, and compressing instead of grinding the coffee beans can enhance a unique flavor and aroma inherent to roasted coffee beans.

### Description of the Related Art

Several factors that determine a flavor of coffee enjoyed by consumers can include species of coffee beans, a roasting level, an aging time of roasted coffee beans, a bean grinding method, a particle size of ground coffee, a coffee dripping method, a ratio of infused coffee to water, type of water and a temperature of the water, as well as various kinds of additives added to coffee. Various flavors of coffee may be selected according to a personal preference of the consumer.

Generally, a coffee preparing process includes a green-bean selecting step, a green-bean processing step, a green-bean roasting step, a roasted bean grinding step, and a coffee dripping step, among others.

Conventionally, as shown in FIG. 1, roasted coffee beans are ground by a grinder 10 to make coffee grinds or powder to be used in an extraction process. For example, the coffee grinds are infused with water and are dripped using a dripper when a person wants to drink coffee. However, coffee grinds from the grinder are not able to fully capture a unique taste of the roasted coffee beans because grinding shears the roasted coffee beans to expose internal portions of the cells or chambers (or cell interiors) of the roasted coffee beans, thereby spilling and scattering contents of the internal portions of the cells or chambers of the roasted coffee beans. When spilled and scattered during the grinding, the contents of the roasted coffee beans become lost while fibers of cell walls of the roasted coffee beans remain, so that a flavor profile of the roasted coffee bean shifts from that of the unique taste of the roasted coffee bean more towards that of the fibers of the cell walls of the roasted coffee beans.

The contents of the internal portions of the cells or chambers of the roasted coffee beans include lipids, various acids, and flavors of the roasted coffee beans, which lends the roasted coffee beans their unique flavor profile if the contents of the internal portions of the cells or chambers of the roasted coffee beans can be prevented from being lost. However, the unique flavor of the roasted coffee beans is deteriorated in the grinding process because the roasted coffee bean is ground in the roasting and grinding processes, and the grinding process scatters the contents of the internal portions of the cells or chambers of the roasted coffee beans to be lost

Also, various methods exist for preparing coffee, including espresso extraction and drip methods using a dripper. Instant coffee mixed with hot water is also widely used.

Instant coffee can be consumed either by mixing coffee powder with hot water or by dissolving in water a mixture of coffee powder, creamer, and sugar, for example.

However, these methods involve grinding roasted coffee beans into powder for extraction, either via an espresso machine or a dripper. Alternatively, ground coffee bean powder can be mixed with water. In such a grinding process, the unique flavor and aroma of roasted coffee beans are often lost, limiting the depth and richness of the coffee's taste.

Therefore, there is a demand for a solution that can address these issues.

### SUMMARY OF THE INVENTION

The embodiments of the present disclosures are directed to addressing a deterioration of a flavor profile of a roasted coffee bean that results from grinding the roasted coffee bean, and are further directed to a method of manufacturing a coffee bean block for brewing coffee with retained flavors.

For example, the embodiments of the present disclosure relate to a method of manufacturing a coffee bean block containing coffee grinds or particles using a milling process and a compressing process, which are intended to prepare coffee drinks that allow people to enjoy a unique, deep and rich flavor of roasted coffee beans that retains the unique, deep and rich flavor of the roasted coffee bean without extraneous tastes such as a carbonization tastes and a burnt taste that are caused by grinding of the roast coffee beans.

Specifically, as conventional grinding of roasted coffee beans causes the coffee cells to shear or tear and break open, such shearing or tearing causes mixing of the contents of coffee cell chamber and components that make up the cell wall or membrane such as fiber, so that taste or flavor of cell membrane forming cell walls are introduced into the flavor profile of coffee brewed from the ground roasted coffee beans.

To counter the introduction of the taste or flavor of the cell membrane from being introduced into the flavor profile of roasted coffee bean, roasted coffee beans are compressed rather than ground to crack open the coffee cell chamber so that the content located within the coffee cell chambers or cell membranes can be accessed, but the contents are not dispersed during a rotational movement of the grinding to become mixed or dispersed. Rather, the compression of the roasted coffee bean maintains the contents of the cell chambers or cell membranes near the opened cell chambers or cell membranes, and are not mixed or dispersed since the compression of the roasted coffee beans simultaneously forms a coffee bean block containing the crushed or pressed coffee particles that are not mixed or dispersed, thus better preserving or maintaining the unique flavor of the roasted coffee beans.

Additionally, the roasted coffee beans are produced by roasting green coffee beans that are first milled to remove an outer layer of the green coffee bean prior to undergoing roasting. Such milling of the green coffee beans removes the fibrous outer surface of the coffee beans that are mostly distal from the cell chambers so that introduction of the flavor of the cell membrane is reduced in the flavor profile of coffee brewed from coffee bean block formed from compressing the roasted coffee beans that have been first milled.

A method of manufacturing a coffee bean block according to an embodiment of the present disclosure includes milling a green coffee bean to remove an outer surface of the green coffee bean to obtain a milled green coffee bean; roasting the milled green coffee bean to obtain a roasted milled coffee bean; placing the roasted milled coffee bean into a forming mold; compressing the roasted milled coffee bean in the forming mold using a pushing rod having a protrusion of a predetermined pattern so that the roasted milled coffee bean is crushed into fragments by the forming mold and the pushing rod; and continue compressing the fragments of the roasted milled coffee bean until the fragments are formed into a compressed coffee bean block.

A method of manufacturing a coffee bean block according to another embodiment of the present disclosure includes a green coffee bean milling operation to remove an outer surface layer of the green coffee bean to produce a milled green coffee bean; a milled green coffee bean roasting operation of roasting the milled green coffee bean obtained from the green coffee bean milling operation to produce a roasted milled coffee bean; and a roasted coffee bean block making operation of compressing the roasted milled coffee bean obtained from the milled green coffee bean roasting operation to produce a coffee bean block.

Also, this invention addresses the shortcomings of traditional methods of making coffee grinds by directly compressing whole roasted coffee beans, without grinding them, into a compressed coffee bean block, thereby enhancing the natural flavor and aroma of coffee beans.

Accordingly, the compressed coffee bean block manufacturing device of the present disclosure, which directly compresses the coffee beans into compressed coffee bean blocks without a grinding process, can enhance the inherent aroma and flavor of the coffee beans.

A compressed coffee bean block manufacturing apparatus according to an embodiment of the present disclosure includes a main unit; a supply unit providing coffee beans to a supply area located within the main unit; a storage unit that receives coffee beans in a storage space device from the supply area and transports coffee beans to a compression area on one side of the supply area; and a compression and discharge unit that compresses and shapes the coffee beans in the compression area into a coffee bean block and then transports the coffee bean block to a discharge area on one side of the compression area for ejection, wherein the supply unit at least one of compresses and crushes at least some of the supplied beans before providing them to the supply area.

The effects according to the present disclosure are not limited to the contents exemplified above, and more various effects are included in the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an image of a conventional coffee grinder that grinds coffee beans.

FIG. 2 is a conceptual image of a device for compressing coffee beans according to an embodiment of the present disclosure.

FIG. 3 is a partially cutaway perspective view illustrating one embodiment of an apparatus for manufacturing a coffee bean block.

FIG. 4 is a partially cutaway perspective view illustrating another embodiment of an apparatus for manufacturing the coffee bean block.

FIG. 5A is a view showing a part of a supply part of the coffee bean block manufacturing apparatus according to an embodiment of the present disclosure.

FIG. 5B is a view showing an arrangement a transfer unit with interacts with a pressing unit that is located to overlap with the transport unit.

FIG. 6 is a view showing a receiving member of the coffee bean block manufacturing apparatus according to an embodiment of the present disclosure.

FIG. 7 is a depiction of a milling device usable to mill green coffee beans.

FIG. 8 is a view of a coffee bean block according to an embodiment of the present disclosure.

FIG. 9 is a flow diagram of a method of manufacturing a coffee bean block using milled coffee beans.

FIG. 10 is a flow diagram of a method of making milled coffee beans.

FIG. 11 is a flow diagram of a method of manufacturing the coffee bean block once the coffee bean has been milled and roasted.

FIG. 12A is an SEM view of crushed coffee particles after compressing of the roasted coffee beans.

FIG. 12B is another SEM view of crushed coffee particles after compressing of the roasted coffee beans.

FIG. 12C is yet another SEM view of crushed coffee particle at a greater magnification.

FIG. 13 is a drawing to explain an overall structure of a compressed coffee bean block manufacturing device according to one embodiment of the present disclosure.

FIG. 14 is a drawing to explain a supply unit of a compressed coffee bean block manufacturing device according to one embodiment of the present disclosure.

FIG. 15 is a drawing to explain a roller section positioned in an internal space of a hopper in a discharge part of the supply unit of the compressed coffee bean block manufacturing device according to one embodiment of the present disclosure.

FIG. 16 is a drawing to explain an eccentric configuration of the discharge part positioned in a central space of the hopper in the supply unit of the compressed coffee bean block manufacturing device according to one embodiment of the present disclosure.

FIGS. 17 to 19 are drawings to explain a modification of the hopper section in the supply unit of the compressed coffee bean block manufacturing device according to one embodiment of the present disclosure.

FIG. 20 is a drawing to explain a variation of the supply unit of the compressed coffee bean block manufacturing device according to one embodiment of the present disclosure, which includes a blocking part, an input part, a displacement sensor, a camera part, a buffer part, and a control unit.

FIGS. 21 and 22 are drawings to explain a receiving unit of the compressed coffee bean block manufacturing device according to one embodiment of the present disclosure.

FIGS. 23 to 26 are drawings to explain a compression/discharge unit of the compressed coffee bean block manufacturing device according to one embodiment of the present disclosure.

FIG. 27 is a drawing to explain a flat support plate in the compressed coffee bean block manufacturing device according to one embodiment of the present disclosure.

FIG. 28 is a drawing to explain disadvantages of using a toothed support plate in a conventional compressed coffee bean block manufacturing device.

FIG. 29 is a drawing to explain an effect of the flat support plate in the compressed coffee bean block manufacturing device according to one embodiment of the present disclosure.

FIG. 30 is a drawing to explain a modification of the support plate with a curvature in the compressed coffee bean block manufacturing device according to one embodiment of the present disclosure.

FIG. 31 is a drawing to explain a state where multiple unit molding spaces with different internal shapes are formed on a rotating member, with one of the unit molding spaces positioned in a compression area in the compression/discharge unit of the compressed coffee bean block manufacturing device according to one embodiment of the present disclosure.

FIG. 32 is a flow diagram of a method of manufacturing a coffee bean block using pre-crushed or pre-cracked coffee beans.

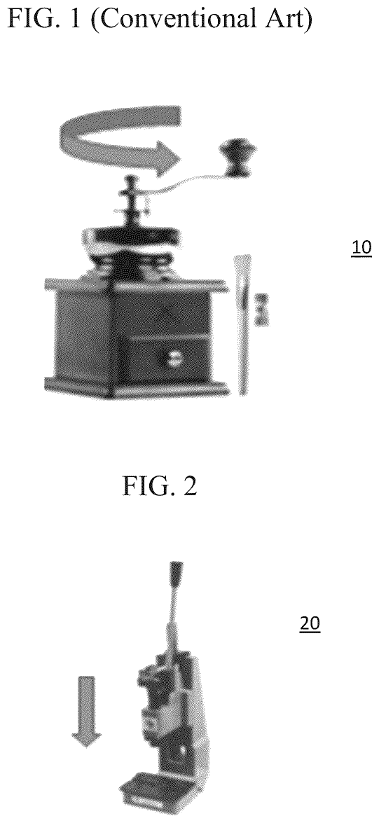

### DETAILED DESCRIPTION OF THE EMBODIMENTS

Advantages and characteristics of the present disclosure and methods of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the example embodiments of the present disclosure and the scope of the present disclosure. Therefore, the present disclosure will be defined by the scope of the appended claims.

Terms such as “first,” “second,” etc., are merely for distinguishing one component from another and should not limit the scope of the claims. For example, the first component can be named the second component, and similarly, the second component can be named the first. When a component is said to be “connected to” another component, it can be directly connected to it or indirectly with an intermediate component. Conversely, “directly connected” implies no intermediate components. Other expressions describing relationships between components, such as “between” and “immediately between” or “neighboring” and “directly neighboring,” should be interpreted similarly.

Singular terms, unless contextually clear, should be understood to include the plural. Terms such as “include” or “have” are intended to specify the existence of stated features, numbers, steps, actions, components, parts, or their combinations, without excluding the presence or addition of other features, numbers, steps, actions, components, parts, or their combinations.

Unless otherwise defined, all terms should be understood with their general meaning as recognized by those skilled in the field. Terms defined in general dictionaries should align with their meaning within the relevant technical context, and unless explicitly defined otherwise, should not be interpreted as ideal or overly formal. Further, terms such as ‘disclosure’ and ‘invention’ are interchangeably used and intend to cover various aspects of the inventions of the present application.

Below, example embodiments of the invention in which the purpose can be specifically realized will be described with reference to the attached drawings.

In explaining this embodiment, identical names and symbols are used for identical components, and additional explanations are omitted.

Hereinafter, a method for manufacturing a coffee bean according to embodiments of the present disclosure will be described with reference to the accompanying drawings.

FIG. 2 is a conceptual image of a device for compressing coffee beans according to an embodiment of the present disclosure.

As provided in FIG. 2, a device 20 can be used to compress roasted coffee beans. The device applies a unidirectional pressure on the roasted coffee beans, whereby the roasted coffee beans are compressed in one direction or along a single direction. By applying pressure in the one direction, the roasted coffee beans are crushed in the one direction so that walls sustaining the internals chambers of the roasted coffee beans crack and the internal chambers collapse under the applied pressure. As pressure application is continued in the one direction, imploded and crushed pieces of coffee beans become compacted to eventually become flattened or compressed. When a vessel is used in the crushing of the roasted coffee beans, the roasted coffee beans can be molded into a shape.

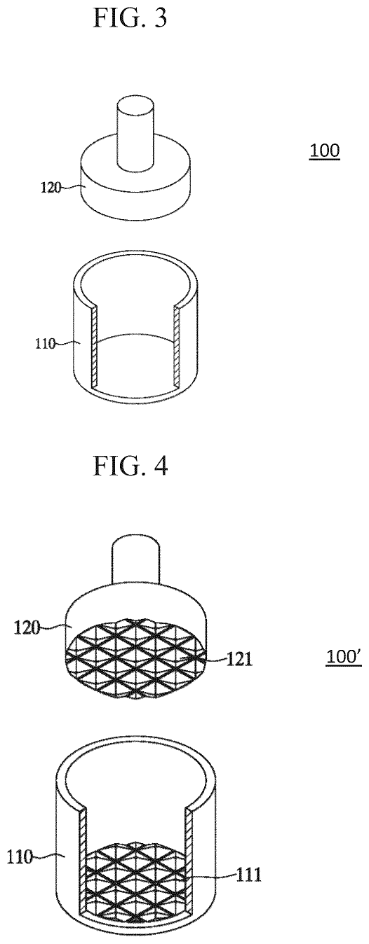

FIG. 3 is a partially cutaway perspective view illustrating one embodiment of a receiving member (or vessel) of an apparatus for manufacturing a coffee bean block (or coffee bean compression block). The apparatus for manufacturing the coffee bean block according to an embodiment of the present disclosure can include the receiving member 100 (or vessel) in a form of a mold 110 having a shape of a tub or a bowl, which can be paired with a push rod 120 having a disc shape. The push rod 120 can be inserted into the mold 110 to crush and compress the roasted coffee bean when the roasted coffee bean is accommodated in the mold 110.

Although each of the mold 110 and the push rod 120 is illustrated as having a circular cross-section, embodiments of the present disclosure are not limited thereto. For example, at least one of the mold 110 and the push rod 120 can have a shape including a circle, a triangle, a rectangle, a hexagon, an octagon, an ellipse, a heart, a water drop, a hemisphere or others, and can be any shape without being limited to the circular cross-section.

FIG. 4 is a partially cutaway perspective view illustrating another embodiment of a receiving member (or vessel) of an apparatus for manufacturing the coffee bean block. The apparatus for manufacturing the coffee bean block according to this embodiment can include the receiving member 100′ (or vessel) in a form of a mold 110 having the shape of a tub or a bowl, which can be paired with a push rod 120 having a disc shape. The push rod 120 can be inserted into the mold 110 to crush and compress the roasted coffee bean when accommodated in the mold 110. An uneven part having an angled protrusion 111 can be formed on a surface of the mold 110, while an uneven part having an angled protrusion 121 can be formed on a surface of the disc of the push rod 120, and engage with the angled protrusion 111 that is formed on the mold 110.

Although each of the angled protrusions 111 and 121 is illustrated as having the shape of a quadrangular pyramid, the embodiments of the present disclosure are not limited thereto. For example, at least one of the angled protrusions 111 and 121 can have various shapes including a cone, a hexagonal pyramid, an octagonal pyramid, and other shapes. As structures having protrusions, the angled protrusions 111 and 121 can apply uniform pressure in several directions, and thus, the angled protrusions 111 and 121 can more smoothly perform the compressive-forming of the coffee bean block in conjunction with the mold 110 and the push rod 120 as compared to when the mold 110 and the push rod 120 only have a smooth surface to contact and crush the roasted coffee beans.

That is, in the process of forming the coffee bean block by the uneven parts including the angled protrusions 111 and 121, the roasted coffee beans can be crushed more evenly and be separated into particles. When both the push rod 120 and the mold 110 have the angled protrusions 121 and 111, respectively, an apex of the angle protrusion 121 can be aligned with four corners of bases of four of the angle protrusions 111, while an apex of the angled protrusion 111 can be aligned with four corners of bases of the angled protrusions 121.

Although disclosed as having protrusions, the uneven parts of the mold 110 and the push rod 120 can include depressions that are in a shape of a recessed quadrangular pyramid or other shapes. For example, the mold 110 can have the uneven part entirely formed of the angled protrusions 111 and the push rod 120 can also have the uneven part entirely formed of the angled protrusions 121 as shown in FIG. 4, but embodiments of the present disclosure are not limited thereto. For example, the mold 110 can have the angled protrusions 111, while the push rod 120 can include the depressions that correspond to the angled protrusions 111 of the mold 110. Oppositely, the mold 110 can include the depressions while the push rod 120 can include the angled protrusions 121 that correspond to the depressions of the push rod 120. But embodiments of the present disclosure are not limited thereto.

In other embodiments of the present disclosure, the push rod 120 can have an arrangement of both the angle protrusions 121 and the depressions that are arranged on the surface of the disc of the push rod 120, and the mold 110 can include an arrangement of both the angled protrusions 111 and the depressions that are arranged on a bottom surface of the mold 110 to correspond to those of the push rod 120.

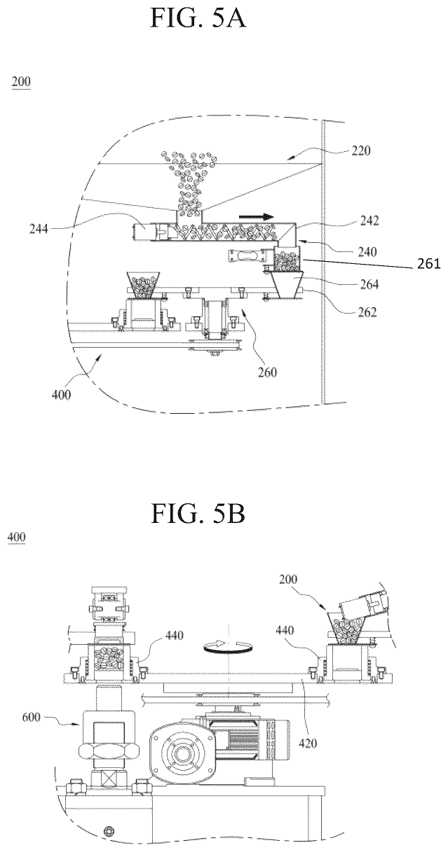

FIG. 5A is a view showing a part of a supply part of a coffee bean block manufacturing apparatus according to an embodiment of the present disclosure. As shown in FIG. 5A, the coffee bean block manufacturing apparatus 200 can include a hopper member 220 to accommodate roasted coffee beans, a transmission member 240 to transfer the roasted coffee beans, a rotation member 260 to measure out a predetermined amount of the roasted coffee beans and to provision the predetermined amount of the roasted coffee beans, a transport unit 400 that rotates the rotation member 260 from a receiving position to a provisioning position, and a receiving member 440 to receive the roasted coffee beans provisioned by the rotating member 260 at the provisioning position. But embodiments of the present disclosures are not limited thereto, and additional elements or members can be included in the coffee bean block manufacturing apparatus 200.

In embodiments of the present disclosure, the hopper member 220 is able to receive the roasted coffee beans and to hold the roasted coffee beans for a predetermined time. To accomplish this task, the hopper member 220 can have a first opening to receive the roasted coffee beans, and a second opening to release the roasted coffee beans. In embodiments of the present disclosure, the first opening and the second opening can be different sizes. For example, the first opening can have a greater size than that of the second opening.

The transmission member 240 can include a discharge tube 242 having an inlet to receive the roasted coffee beans and an outlet to output the roasted coffee beans. The transmission member 240 can also include a controlling element 244 that controls receipt, transfer, and output of the roasted coffee beans as the roasted coffee beans are moved or transported through an interior of the transmission member 240. The roasted coffee beans can be moved through the interior of the transmission member 240 by various means. Such means can include a piston to push the roasted coffee beans, or can be means that transport the roasted coffee beans, such as a screw or a screw mechanism that rotates along an axis and sequentially moves the roasted coffee beans from the inlet to the outlet of the transmission member 240, but embodiments of the present disclosure are not limited thereto, and other means of transporting the roasted coffee beans can be used. For example, the transmission member 240 can be tilted so that gravity is used to move the roasted coffee beans from the inlet to the outlet.

As the roasted coffee beans arrive at the outlet of the transmission member 240, a drive motor can be provided at an end of the discharge tube 242 which can discharge the roasted coffee beans to a holding chamber so that a precise or predetermined amount of roasted coffee beans is measured and delivered. When discharging the predetermined amount of the roasted coffee beans, a lower part of the discharge tube 242 can be opened and closed.

Also, instead of relying on gravity and a downward slope of the discharge tube 242, the discharge tube 242 can be horizontal or can be sloped upward from the inlet to the outlet. When the discharge tube 242 is horizontal or sloped upward, a more precise control of an amount of roasted coffee beans can be supplied to the second end of the discharge tube 242 by use of an internal moving device such as the screw or the screw mechanism that can rotate about an axis extending from a first end to a second end, and move the roasted coffee beans from the first end adjacent the inlet to the second end adjacent the outlet. A drive motor can be connected to the screw to rotate the screw.

The amount of the roasted coffee beans can be calibrated in part by the number of rotations the screw is rotated, for example. The roasted coffee beans that are measured and driven by the screw from the inlet to the outlet of the discharge tube 242 can then exit through the outlet to be held by a measurer 261 located adjacent the outlet of the discharge tube 242. The measurer 261 can include a weight device that can precisely measure an amount of roasted coffee beans to be supplied to a supply cup 262. The supply cup 262 can deliver the roasted coffee beans to a receiving member 440 that can crush and shape the roasted coffee beans into a coffee bean block.

In various embodiments of the present disclosure, the measurer 261 can include a receiving end to receive the amount of roasted coffee beans and a supplying end that discharges the roasted coffee beans once a precise amount of roasted coffee beans are received in the measurer 261. The sizes or dimensions of the receiving end and the supplying end of the measurer 261 can be the same or different sizes. When of different sizes, the size of the receiving end can be greater than the size of the supplying end. A door can be located at each of the receiving end and the supplying end of the measurer 261 to assist in the measurer 261 providing the precise amount of the roasted coffee beans to the supply cup 264, whereby the door at the receiving end can close as soon as the precise amount of roasted coffee beans are supplied to the measurer 261, and the door at the supplying end can open simultaneously or as soon as the precise amount of roasted coffee beans is measured. However, the opening and closing of the doors at the receiving end and the supplying end of the measurer 261 can be at different times in various embodiments of the present disclosure.

The supply unit 200 can further include the rotation member 260. The supply unit 200 can be linked to a driving pulley in order to be connected with a transport unit 400 via a means such as a belt, and the link between the supply unit 200 and the transport unit 400 enables the rotation member 260 to circulate between the receiving member 440 and the measurer 261. The driving pully connected to the belt can rotate about an axis, and can supply a rotational movement to one or more supply plates 262 that support one or more supply cups 262.

FIG. 5B is a view showing an arrangement of a transfer unit 400 that interacts with a pressing unit 600 that is located to overlap with the transport unit 400. Pressing portions of the pressing unit 600 can be arranged on opposite sides of the transfer unit 400 and form a gap therebetween so as to allow the transfer unit 400 to rotate in between the pressing portions and to align with the pressing unit 600. The pressing portions can be provided in a pair, so that a first pressing portion can press down from an upper side and a second pressing portion can press up from a lower side of the transfer unit 400.

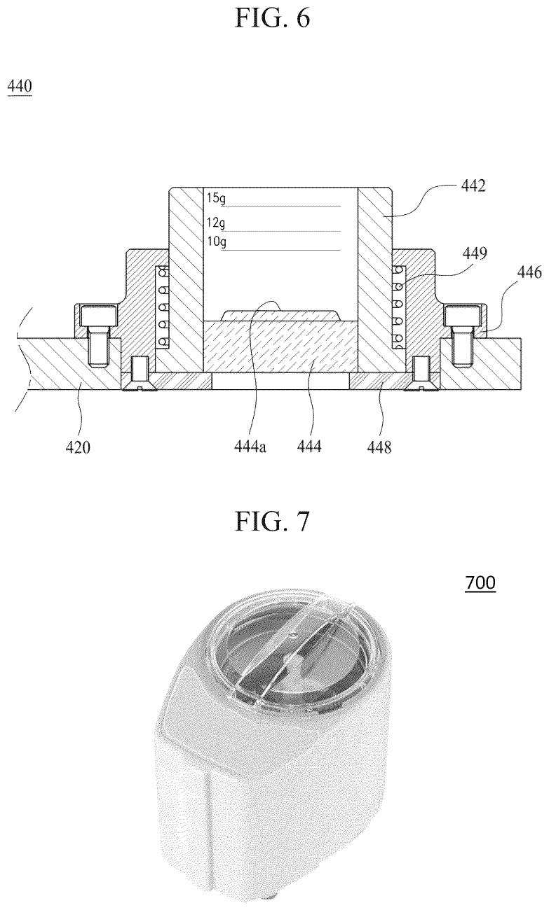

FIG. 6 is a view showing a receiving member of the coffee bean block manufacturing apparatus according to an embodiment of the present disclosure. As shown in FIG. 6, the transfer unit 400 can include a rotation plate 420 and a receiving member 440 supported by the rotation plate 440. The receiving member 440 can include a receiving body 442, a compression plate 444, a pattern generating plate 444a, a support plate 446, a fixing plate 448 and an elastic member 449. But embodiments of the present disclosure are limited thereto.

The receiving member 440 has the receiving body 442 having a first side that is open to receive roasted coffee beans from the coffee bean block manufacturing apparatus 200 and a second side that is opposite to the first side. The compression plate 444 can be located within the receiving body 442, and the compression plate 444 can be movable within the receiving body 442. The fixing plate 448 can include an aperture that overlaps the compression plate 444 to receive the second pressing portion of the pressing unit, while the first pressing portion can be received into the receiving body from the first side of the receiving body. When in operation, the first pressing portion and the second pressing portion can compress the roasted coffee beans within the receiving body 442 from opposite sides of the receiving body to form the coffee bean block by compression.

In other embodiments of the present disclosure, the second pressing portion need not extend through the aperture in the fixing plate 448, but can simply support the fixing plate 448 while the first pressing portion presses the roasted coffee beans located within the receiving body 442 from the first side of the receiving body 442.

The receiving member 440 can be detached from the rotation plate 420 for case of cleaning, or for replacement when the receiving member 440 or any parts thereof becomes worn or broken. Also, when a size of the coffee bean block or an amount of coffee particles are to be changed, a different sized receiving member 440 can be attached to the rotation plate 420. Various means of attaching the receiving member to the rotation plate 420 can be used, such as screws, rivets, and others.

The receiving body 442 can be inserted into a space formed by the support plate 446 and be seated therein. The elastic member 449 can be provided in the space or gap between the receiving body 442 and the support plate 446 to maintain contact between the receiving body 446 and the fixing plate 448 but allow for movement of the receiving body 442 relative to the fixing plate 448.

The compression plate 444 can be fixed to at least one of the receiving body 446 and the fixing plate 448, or can be movable within the receiving body 442. The receiving body 442, the compression plate 444 and the first and second pressing portions can have a cylindrical shape, but such is not required, as other shapes can be provided such as rectangular, polygonal, hemispherical, semicircular, or annular in order to mold a shape the coffee bean block accordingly.

The pattern generating plate 444a can be formed or placed on a surface of the compression plate 444 that faces an interior of the receiving body 442 towards the roasted coffee beans. A pattern provided by the pattern generating plate 444a can be the shape of the quadrangular pyramid as discussed above or other shapes as previously discussed. The pattern provided by the pattern generating plate 444a can be imparted onto the coffee bean block. Also, the first pressing portion of the pressing unit 600 can also have a pattern to be imparted onto the coffee bean block, which can be the same or different than that of the pattern generating plate 444a.

In various embodiments of the present disclosure, the receiving member 440 corresponds to the receiving member 110 and 110′ of FIGS. 3 and 4, respectively. For example, the receiving body 442 can correspond to the mold 110, the first pressing portion can correspond to the push rod 120, and the pattern generating plate 444a and correspond to the angled protrusions 111.

FIG. 7 is a depiction of a milling device usable to mill green coffee beans. The milling device according to an embodiment of the present disclosure can include a cylindrical vessel having mesh walls, a rotating blade in a center of the cylindrical vessel to stir green coffee beans when accommodated in the cylindrical vessel, and a cover that closes the milling device. As the rotating blade is rotated by a motor, the green coffee beans are stirred and come into contact with the mesh wall that acts as a grater to cut away or mill an outer surface layer of each coffee bean. In embodiments of the present disclosure, the milling device can be provided to have a blade in the center that is non-rotating and instead, have the cylindrical vessel with the mesh walls be rotating to mill the green coffee beans. In other embodiments of the present disclosure, both the blade and the cylindrical vessel can be rotating, either in a same direction or in opposite directions. If rotating in the same direction, the speed of rotation between the blade and the cylindrical vessel can be the same or different. The speeds of rotation for the blade and the cylindrical vessel can vary in both the same direction rotation and the opposite direction rotations. In various embodiments of the present disclosure, green coffee beans refer to coffee beans that have not undergone a roasting process or has undergone a partial roasting process. For example, green coffee beans can refer to any bean that that has been dried and up to a bean that has gone through a partial roasting process, but embodiments of the present disclosure are not limited thereto. For example, green coffee beans can refer to roasted beans that have become darker via application of heat, but have not yet formed a first crack.

The coffee bean that is milled can be a green coffee bean that has not been roasted. For example, after being dried, but before being roasted, the green coffee beans can be milled to remove a thin layer of an outer surface of the green coffee bean. An amount of removal can be between 0.01 um to 10 um in thickness, such as between about 0.05 um to 5 um, between about 0.09 um to 2 um, between about 0.09 um to 1.0 um, between about 0.09 um to 0.5 um, between 0.09 um to 0.4 um, between 0.09 um to 0.3 um, between 0.09 um to 0.2 um, between 0.09 um to 0.15 um, between 0.09 um to 0.13 um, between 0.09 um to 0.11 um, or other range between about 0.01 um to 1.0 um. In other embodiments, an amount of the outer surface of the green coffee bean that is milled is about 0.1 um in depth or thickness.

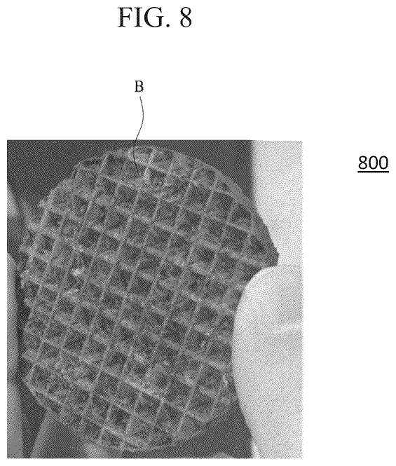

FIG. 8 is a view of a coffee bean block according to an embodiment of the present disclosure. The coffee bean block 800 according to an embodiment of the present disclosure can have uneven parts B formed on surfaces of the coffee bean block, for example, upper and lower surfaces thereof.

The uneven parts B according to this embodiment are formed when pressure is evenly applied to coffee grains in the process for forming the coffee bean block to allow each bean to be uniformly separated into fine-sized particles in the compressing process, thereby increasing the contact area of the particles with water in the process of extracting the coffee such as an espresso, dripping or brewing the beans in water to prepare various coffee drinks, and maintaining a uniform coffee taste without the impure taste of the fibers of the coffee beans.

In embodiments of the present disclosure, the uneven parts B can be various patterns such as concentric patterns, other geometric patterns, animal patterns, or trademark patterns, company logos, text, letters or scripts, or one or more combinations thereof. Also, the upper and lower surfaces of the coffee bean block need not include the uneven parts B or the patterns, and can be smooth, or partially smooth and partially patterned. In other embodiments of the present disclosure, the lateral surface or edge of the coffee bean block can also include the uneven parts B or various patterns.

When about 100 grams of milled and roasted coffee beans are used to make the coffee bean block, and when a 700 grams of water at 95 degree Celsius is used to brew coffee for 3 minutes, about 540 grams to 560 grams of coffee can be provided. The coffee brewed from a coffee bean block that was made using milled and roasted coffee beans can have a brix value between about 2.22 brix to 3.5 brix, for example, about 2.4 brix.

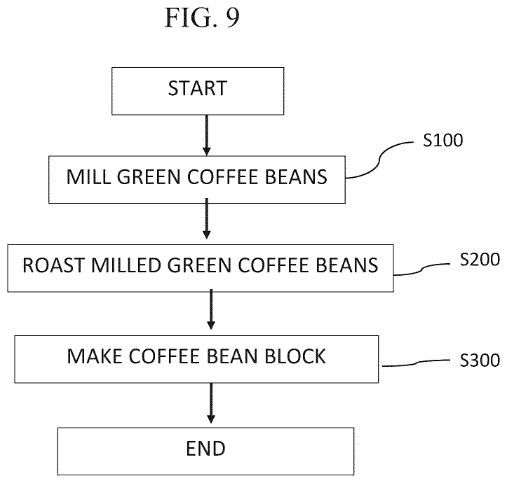

FIG. 9 is a flow diagram of a method of manufacturing a coffee bean block using milled coffee beans. As shown in FIG. 9, the method can include a green coffee bean milling operation S100, a milled green coffee bean roasting operation S200 and a roasted coffee bean block making operation S300. In various embodiments of the present disclosure, operations S100, S200 and S300 can be performed in the order shown, but embodiments of the present disclosure are not limited thereto. For example, the green coffee bean milling operation S100 can be performed to produce milled green coffee bean, which can be sold without performing the subsequent operations of roasting the milled green coffee beans and/or making the coffee bean block, or milled green coffee beans can be purchased or obtained to perform the operations of roasting the milled green coffee beans and/or making the coffee bean block. Further, the operations of the method need not be performed in close chronological order, but can be performed with gaps in time of over several hours, days or weeks.

In various embodiments of the present disclosure, the green coffee bean milling operation S100 can be performed using a milling device, and such milling device can include that shown in FIG. 7, or other milling devices such as commercial milling devices that can mill green coffee beans in greater scale, or commercially.

In various embodiments of the present disclosure, the milled green coffee bean roasting operation S200 can be performed using a home roasting device or roasting devices such as commercial roasting devices that can roast green coffee beans in greater scale, or commercially.

In various embodiments of the present disclosure, the roasted coffee bean block making operation S300 can be performed using a compressing device, a vessel, a receiving member, a supply part and/or apparatus for manufacturing a coffee bean block as shown in FIGS. 2, 3, 4, 5A, 5B and 6, or other devices such as commercial coffee bean block manufacturing devices that can make roasted coffee bean blocks commercially.

In various embodiments of the present disclosure, the method of manufacturing a coffee bean block using milled coffee beans is not limited to the operations shown in FIG. 9, but can further include additional operations.

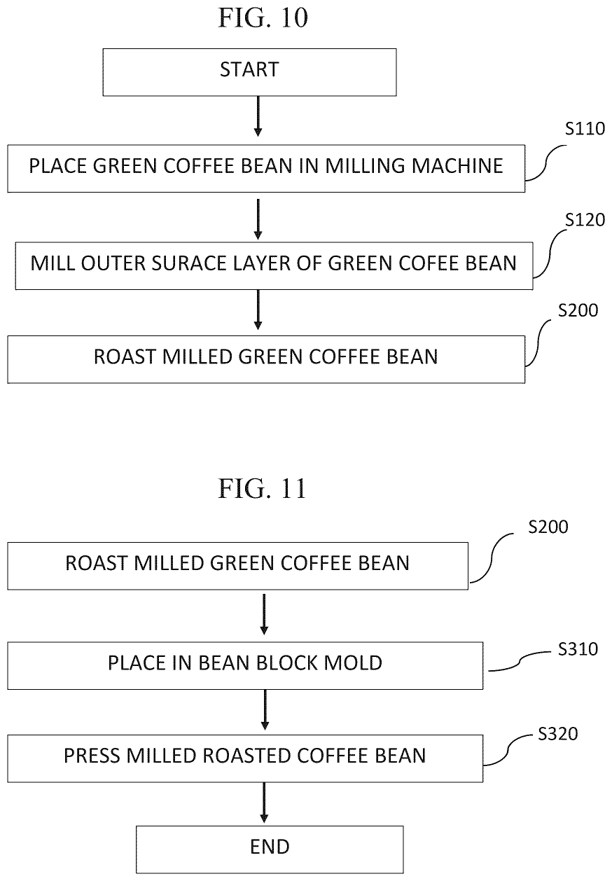

FIG. 10 is a flow diagram of a method of making milled coffee beans. FIG. 10 shows a detail of the green coffee bean milling operation S100 of FIG. 9. As shown in FIG. 10, the method of making milled coffee beans can include a green coffee bean placing operation S110 of placing the green coffee bean in a milling machine or a milling device and an outer surface layer milling operation S120 of milling an outer surface layer of the green coffee bean. Once the outer surface layer milling operation S120 is performed, the milled green coffee bean can further proceed to being roasted (S200).

During the outer surface layer milling operation S120, green coffee beans can be milled for between about 10 seconds to 30 minutes. The milling operation of the green coffee beans can proceed continuously for a pre-determined time, or can be separated into two or more time periods. In one embodiment of the present disclosure, the green coffee bean can be milled for a total of 30 minutes, in 5 minute increments so that 6 increments are provided. The time for each increment, and the number of increments can be varied. Another embodiment of the present disclosure includes a total milling time of about 21 minutes, and includes 3 increments, so that the time for each increment can be about 7 minutes. The amount of non-milled green coffee beans used can be about 250 grams for each batch, but embodiments of the present disclosure are not limited thereto.

Additionally, during the outer surface milling operation S120, the green coffee bean can be milled to remove the thin layer of the outer surface of the green coffee bean. An amount of removal can be between 0.01 um to 10 um in thickness, such as between about 0.05 um to 0.5 um, or between about 0.09 um to 0.2 um, between about 0.09 um to 1.0 um, between about 0.09 um to 0.5 um, between 0.09 um to 0.4 um, between 0.09 um to 0.3 um, between 0.09 um to 0.2 um, between 0.09 um to 0.15 um, between 0.09 um to 0.13 um, between 0.09 um to 0.11 um, or other range between about 0.01 um to 1.0 um. In other embodiments, an amount of the outer surface of the green coffee bean that is milled is about 0.1 um in depth or thickness thereof.

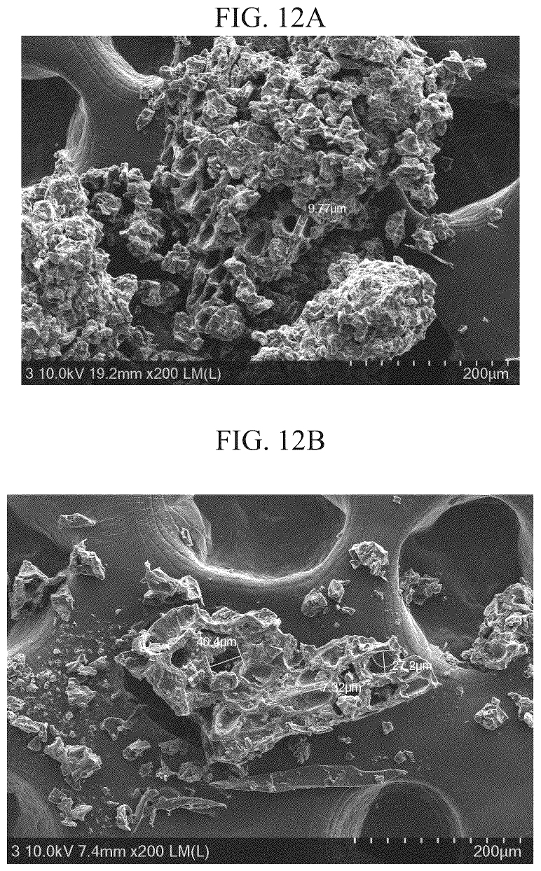

FIG. 11 is a flow diagram of a method of manufacturing the coffee bean block after the coffee bean has been milled and roasted. FIG. 11 shows a detail of the roasted coffee bean block making operation S300 of FIG. 9. As shown in FIG. 11, the method of manufacturing the coffee bean block can include a roasted coffee bean placing operation S310 of placing the roasted coffee bean in a bean block mold, the roasted coffee bean being sourced from the coffee bean roasting operation S200. The method further includes a roasted coffee bean pressing operation S320 of pressing the roasted milled coffee bean using the bean block mold. Thereafter the operation ends.

In the method of FIG. 11, the bean block mold used can be the vessel, the receiving member, or any apparatus for manufacturing a coffee bean block as shown in FIGS. 2, 3, 4, 5A, 5B and 6, but embodiments of the present disclosure are not limited thereto.

In embodiments of the present disclosure, the process of manufacturing the coffee bean block involves placing the milled and roasted whole coffee beans into a certain mold, and the milled and roasted whole coffee beans are pressed into a shape of the mold, such as a disc shape.

The coffee bean block can be made by pressing the milled and roasted whole coffee bean by applying a certain pressure. At this time, a volume of the whole coffee beans can be reduced by greater than half of an original volume of the whole coffee beans. In various embodiments of the present disclosure, the volume of the coffee bean block can be about ½ or less of the original volume of the whole coffee beans, for example, ⅖ or less. In one embodiment of the present disclosure, the volume of the coffee bean block can be about ⅕ of the original volume of the whole coffee beans. The compression of the whole coffee beans into a coffee bean block can be expressed as a ratio.

Assuming that a volume of the whole coffee bean is V0 and a volume of a compressed coffee bean block is V1, a ratio of V1/V0 can be about 0.15 to 0.5 according to a roasting level and an extraction method of the coffee bean. In embodiments of the present disclosure, the V1/V0 can be any value between about 0.15 to 0.5. For example, the ratio of V1/V0 can be about 0.2.

When the compression ratio is 0.5 or more, a formability of the coffee bean block can be deteriorated and the whole coffee beans may be separated into large particles, so that a solubility in water may become poor. Meanwhile, when the compression ratio is 0.1 or less, pressure should be correspondingly increased, so that a large amount of fat ingredients may be undesirably extracted.

When compressing the whole coffee beans, a pressure that can be applied is equal to or greater than about 1500 kg/cm². When the pressure is less than 1500 kg/cm², the coffee particles constituting the coffee bean block can remain large in size, so that the coffee particles are difficult to dissolve in water. But embodiments of the present disclosure are not limited thereto, and pressures less than 1500 kg/cm² can be used in various embodiments.

A protrusion of a predetermined pattern is disposed on any one of the forming mold and the push rod to imprint a protrusion shape. In this instance, the whole coffee beans are those that have been milled and/or roasted before being pressed.

In embodiments of the present disclosure, the compressing occurs in only one direction. The compression causes crushing of the whole coffee beans to occur. As pressure is applied to the whole coffee beans, the forces applied to the cell walls of the whole coffee beans breaks the cell walls to cause a collapse of the cell rooms, or the internal portions of the cells or chambers, or the cell interiors of the roasted coffee beans.

The coffee bean block according to embodiments of the present disclosure is configured such that much fiber constituting the cell membrane of the whole coffee beans is not destroyed and add to the flavor of the coffee drink, like when grinding the whole coffee beans by a blade. By the process of compressive forming of the coffee bean block, relatively many cracks are formed along a honeycomb-shaped cell membrane constituting the whole coffee beans, and the whole coffee beans are separated into fine coffee particles in this process, so that an impure taste of coffee caused by destruction of the fibers of the coffee cell membrane due to contact of fiber with a grinding blade of a grinder is not generated when coffee is prepared by dripping or brewing the coffee bean block or the coffee particles in water, thus minimizing the impure taste of coffee such as burnt taste, and no frictional heat is applied to the whole coffee beans by the grinding blade, thus minimizing burnt taste due to carbonization due to heat from friction.

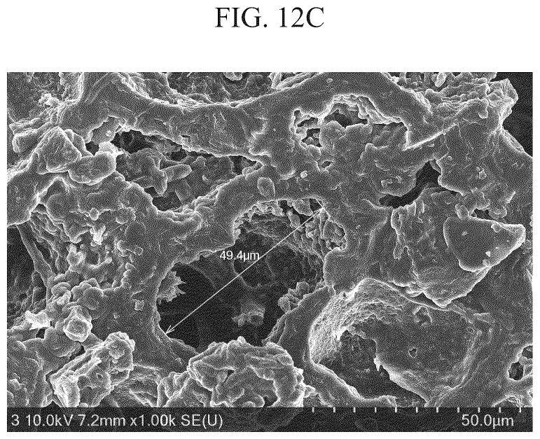

FIG. 12A is a scanning electron microscope (SEM) view of crushed coffee particles after compressing in 200 times magnification. FIG. 12B is another scanning electron microscope (SEM) view of crushed coffee particles after compressing in 200 times magnification. FIG. 12C is yet another scanning electrode microscope (SEM) view of crushed coffee particle at 1000 times magnification.

Unlike roasted coffee beans that have been ground using coffee grinders, crushed coffee particles are generated by applying pressure in only one direction. As shown in FIGS. 12A, 12B and 12C, a significant portion of the coffee particles show a compressed appearance where internal cells or chamber are collapsed. Because the cell walls are not shredded in the crushed coffee particles, unlike those of ground coffee particles, it can be seen that the cell wall thickness is uniform. That is, although the cells themselves are destroyed due to compression, but the cell walls are not torn and the original cell wall shape of the coffee beans are maintained. Further, even when the cell chamber of the coffee particle have collapsed, the cell wall is simply broken open and there are many parts where the cell wall components are not exposed.

Additionally, when coffee of milled, compressed or crushed coffee particles are compared to coffee of normally ground coffee particles, differences appear in terms of caffeine and acrylamide, among others. Acrylamide has posed a concern as a possible carcinogen in some studies. As shown in Table 1, below, coffee of milled, compressed particles (A) have less caffeine compared to coffee of the particles of the comparative example (B) that have been ground normally. For example, caffeine in (A) can be about 94.01 mg/100 g and caffeine in (B) can be about 133.36 mg/100 g, so that a ratio of (A)/(B) of caffeine is about 70%. Accordingly, the amount of caffeine in coffee of milled, compressed or crushed coffee particles can be less than that of normally ground coffee particles.

Also, as shown in Table 1, below, coffee of milled, compressed particles (A) have less acrylamide compared to coffee of the particles of the comparative example (B) that have been ground normally. For example, acrylamide in (A) can be about 12.5 μg/kg and acrylamide in (B) can be about 17.21 μg/kg, so that a ratio of (A)/(B) of acrylamide is about 73%. Accordingly, the amount of acrylamide in coffee of milled, compressed or crushed coffee particles can be less than that of normally ground coffee particles.

TABLE 1

| | | Milled, | | |
|---|---|---|---|---|
| | | Compressed | Comparative | |
| Item | Unit | Coffee (A) | Example (B) | (A)/(B) |
| Caffeine | mg/100 g | 94.01 | 133.36 | 70% |
| Acrylamide | μg/kg | 12.5 | 17.21 | 73% |

According to an aspect of the invention, the method for manufacturing a coffee bean block, for a coffee drink intended to reduce burnt taste and increase flavor in the coffee drink, with a protrusion shape being imprinted on the block, includes milling a coffee bean to remove an outer surface of the coffee bean. Thereafter, the coffee bean is placed into a forming mold. Once in the forming mold, the coffee bean is compressed in the forming mold using a pushing rod having protrusion of a predetermined pattern so that the coffee bean is crushed into fragments by the forming mold and the pushing rod. The fragments of the coffee bean are continued to be compressed until the fragments are formed into a compressed block.

The reason is as follows: if the roasted coffee bean is compressed without any process, cracks occur along the cell membrane of a honeycomb structure constituting the bean in the process of compressing the coffee bean to finely separate it into small coffee particles, so that the forcible destruction of the fiber constituting the cell membrane of the coffee bean is reduced, and thereby various impure tastes of coffee included in the fiber are not generated, thus reducing the impure taste such as the burnt taste of coffee, and the frictional heat between the grinding blade and the coffee bean generated during the grinding is eliminated, so that the burnt taste of the coffee fat is minimized, and coffee oil ingredients making aroma deep ooze out and flavor is retained, so that a rich coffee body is achieved and the unique flavor of the coffee is retained.

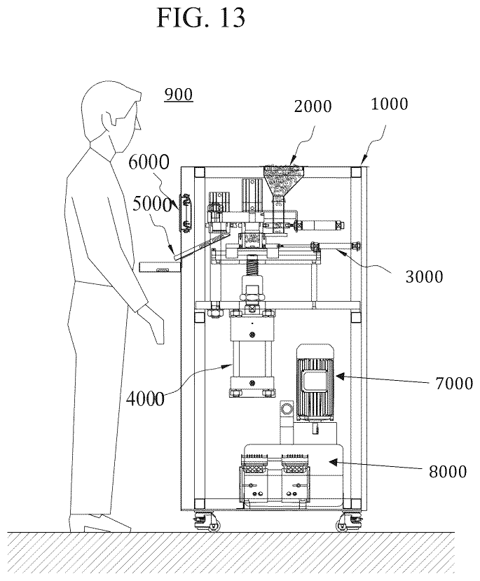

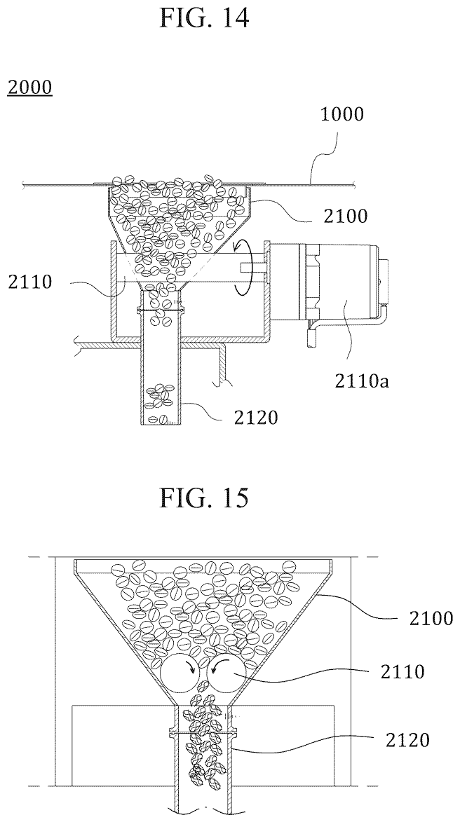

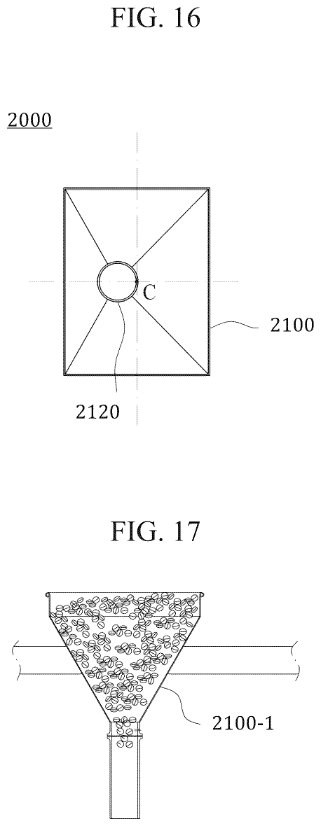

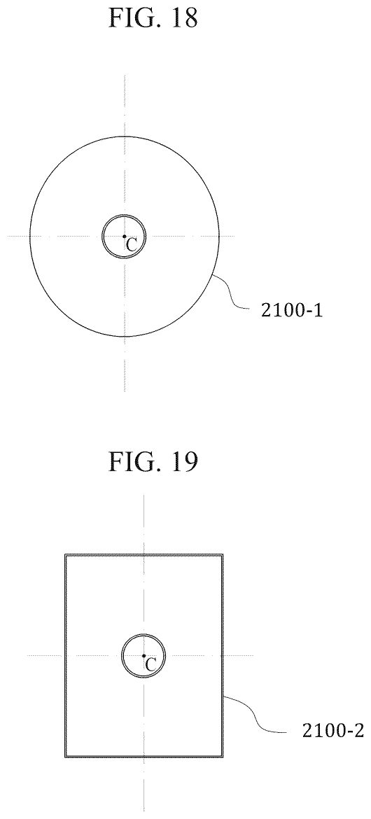

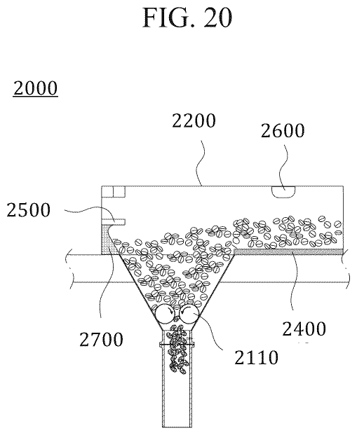

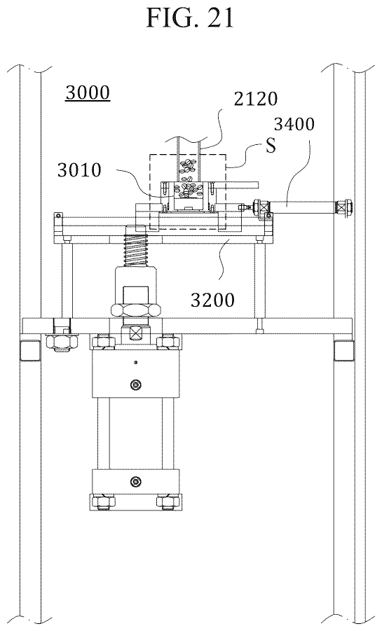

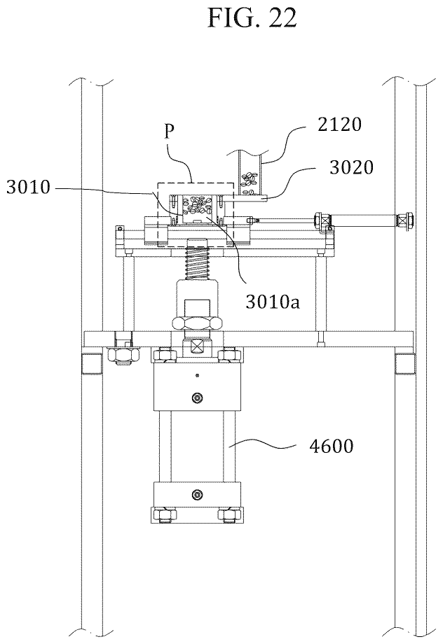

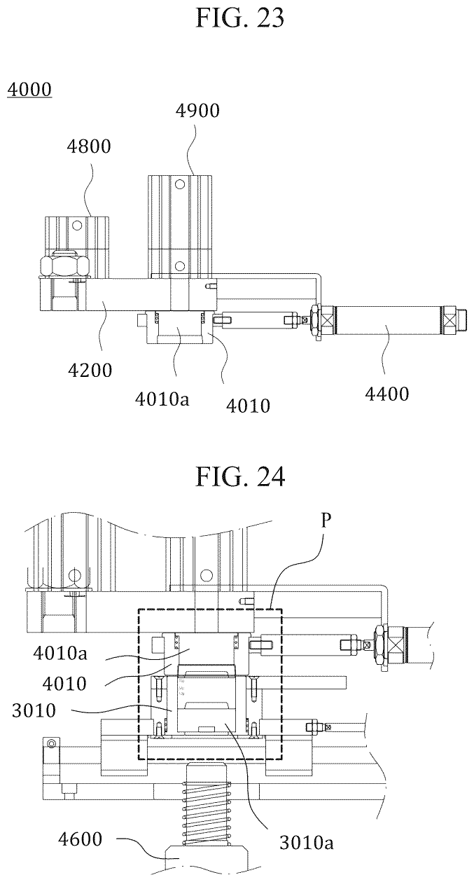

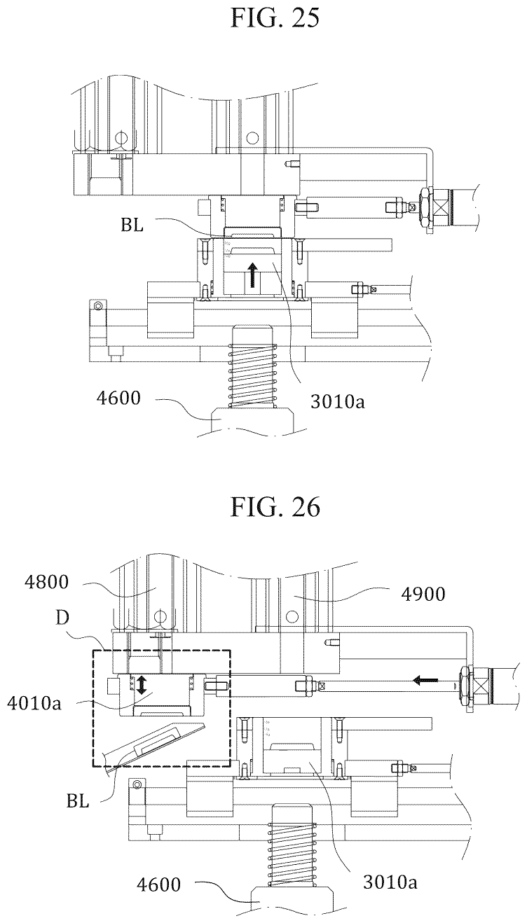

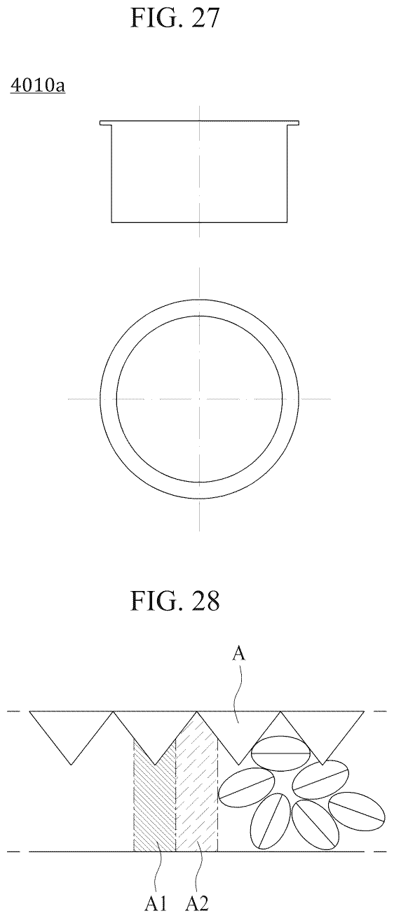

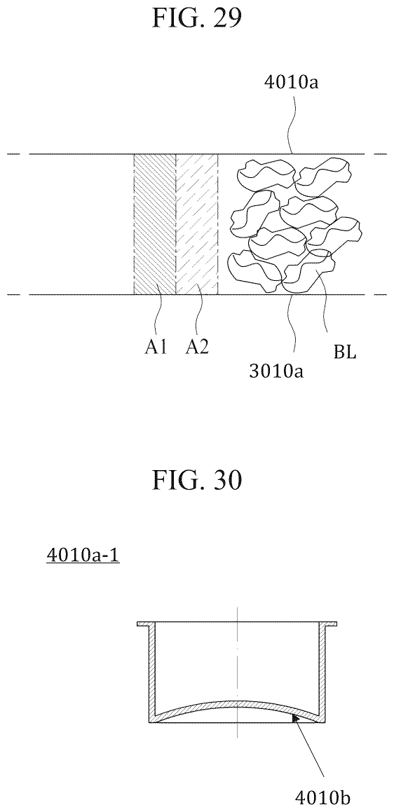

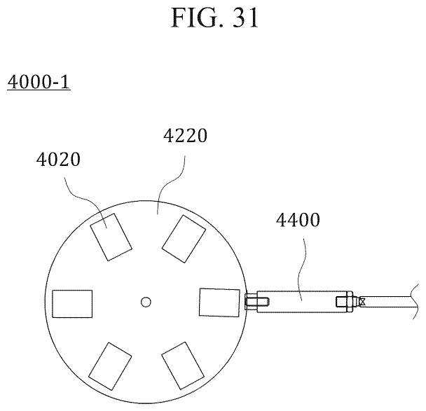

FIG. 13 illustrates the overall appearance of a compressed coffee bean block manufacturing apparatus according to one embodiment of the present invention, FIG. 14 illustrates the supply unit, FIG. 15 shows the roller section of the supply unit positioned in the internal space of the hopper section, FIG. 16 illustrates the eccentric form of the discharge section within the center of the hopper space, FIGS. 17 to 19 show variations of the hopper section, FIG. 20 illustrates an alternative with additional components such as the blocking part, the feeding part, displacement sensor, camera part, buffer part, and control unit, FIGS. 21 and 22 explain the storage unit, FIGS. 23 to 26 explain the compression and discharge unit, FIG. 27 explains a flat support plate, FIG. 28 describes drawbacks of using a toothed support plate in a conventional apparatus, FIG. 29 explains the benefits of a flat support plate, and FIG. 30 shows an example of a curved support plate, while FIG. 31 explains the compression and discharge unit's rotation with various forming spaces for compression.

First, the compressed coffee bean block manufacturing apparatus 900 according to one embodiment of the present invention can include a main unit 1000, a supply unit 2000, a storage unit 3000, and a compression and discharge unit 4000, but embodiments are not limited thereto.

As shown in FIG. 13 (and also FIGS. 21 and 22), a supply area S is formed within the internal space of the main unit 1000, and coffee beans can be supplied to this area through the supply unit 2000. The storage unit 3000 can receive coffee beans from the supply unit 2000 in the supply area S and move the coffee beans to the compression area P. The compression and discharge unit 4000 can compress the coffee beans stored in the storage unit 3000 within the compression area P to create compressed coffee bean blocks. The compressed coffee bean block can then be moved to the discharge area D (see FIG. 26) for ejection by the compression and discharge unit 4000.

Additionally, a guide unit 5000 positioned on one side of the main unit 1000 can receive the ejected compressed coffee bean blocks and transport them outside of the main unit 1000. The guide unit 5000 can form a transport path from the inside to the outside of the main unit 1000. If the guide unit 5000 safely transfers the compressed coffee bean block without damage and transports the compressed coffee bean block outside for the user, the system can be set up as an automatic conveyor belt or, as shown in the figures, as a manually inclined structure and still fall within the scope of the present disclosure. The guide unit 5000 can also have a shock-absorbing pad in certain areas to mitigate external force transmitted to the compressed coffee bean block.

Additionally, the compressed coffee bean block manufacturing apparatus can include a control unit 6000 on another side of the main unit 1000, enabling the user to control the operations of the supply unit 2000, the storage unit 3000, the compression and discharge unit 4000, and the guide unit 5000 from the outside. Also, a motor unit 7000 and a power unit 8000 can be provided.

Through the configurations described above, the compressed coffee bean block manufacturing apparatus according to one embodiment of the present disclosure can adjust operating conditions to produce desired forms of compressed coffee bean blocks based on various types of coffee beans and environmental factors such as temperature and humidity.

As described above, the supply unit 2000 can receive coffee beans from the outside and supply the coffee beans to the supply area S within the main unit 1000. Specifically, the supply unit 2000 can include a hopper section 2100, a roller section 2110, and a discharge section 2120. Other elements can be further included.

As shown in the drawings, the hopper section 2100 can be prepared in a polyhedral form, providing space to hold coffee beans inside. The supply unit 2000 can include a roller section 2110 to crush and/or press the supplied coffee beans at least partially before providing the partially crushed and/or pressed coffee beans to the supply area S. The roller section 2110 can be coupled to a motor 2110a to be rotated.

Specifically, the roller section 2110 can be installed as a pair of rollers within the space of the hopper section 2100 to crush and/or press the coffee beans introduced into the hopper section 2100. The roller section 2110 can include one pair of rollers, but such is not required. For example, when there is sufficient space within the hopper section 2100 for more than one pair of rollers of the roller section 2110, then multiple pairs of rollers can be arranged in the hopper section 2100 along the direction toward the discharge section 2120, and this would still fall within the scope of the invention. In various embodiments of the present disclosure, the roller section 2110 can have a setting that does not crush and/or press the supplied coffee beans, but simply allow free passage of the coffee beans between a spacing between each pair of rollers in the roller section 2110. A setting that allows free passage of the coffee beans can be referred to as a bypass mode of the roller section 2110. When in the bypass mode, the spacing between each pair of the rollers can be greater than about 95% of an average size of one or more roasted coffee beans. For example, the spacing between each pair of the rollers can be about 100% to 1000% of the average size of one or more roasted coffee beans. In other embodiments of the present disclosure, the bypass mode moves the each pair of the rollers away from a path of the roasted coffee beans.

Additionally, when a pair of rollers within the space of the hopper section 2100 to crush and/or press the coffee beans, such can be referred to as an engaged mode. In the engaged mode, the spacing or a gap between each pair of rollers in the roller section 2110 can be adjustable. Thus, the roller section 2110 can initially crush or crack the coffee beans, prior to having the coffee beans be subjected to full compression in a subsequent process, and the initially crushed or cracked coffee beans are then transferred to the discharge section 2120.

In various embodiments of the present disclosure, the gap between each pair of the rollers in the roller section 2110 can be about 5% to about 95% of an average size of one or more roasted coffee beans. On the higher end of a range of the gap, such as between about 50% to about 95%, the roasted coffee beans that pass through between each pair of the rollers can be cracked without being granulated so that each roasted coffee beans can remain intact without pieces of the roasted coffee beans separating from each other. But such is not required, and some or all of the coffee beans that pass through each pair of rollers having the gap at about 50% to about 95% of the average size of one or more roasted coffee beans can be broken into a few pieces, such as between 2 to about 10 pieces. When broken into pieces, each piece of the broken roasted coffee bean can be a size of about 50% to 10% of that of an unbroken roasted coffee bean. Accordingly, by using the roller section 2110, the roasted coffee beans can be pre-cracked or pre-crushed into fragments of certain sizes and shapes so that subsequent forming of the coffee bean blocks can proceed more smoothly or easily by using less force and/or being formed with more consistency in size than when a full coffee bean is to be crushed without being pre-cracked or pre-crushed.

Also, on the lower end of the range of the gap, such as between about 5% to about 50% of the average size of one or more roasted coffee beans, the roasted coffee beans can be broken into a plurality of pieces that have sizes that are between 10% to 1% of an unbroken roasted coffee bean.

In various embodiments, a plural pairs of rollers of the roller section 2110 can be arranged sequentially, where gaps between each pair of the plural pairs of the rollers can vary or can be the same. When the gaps between each pair of the plural pairs of the rollers are the same, then the roasted coffee beans will acquire consistent cracks or can be broken into consistent sized pieces or fragments. Also, when the gaps between each pair of the plural pairs of the rollers vary, such as being increasingly narrow, then the roasted coffee beans can increasingly be broken into smaller pieces so that a consistent sized pieces of the broken coffee beans can be obtained. But embodiments of the present disclosure are not limited thereto.

In various embodiments of the present disclosure, one or more of the pairs of rollers of the roller section 2110 can be referred to as a pre-crushing roller that is designed to adjust density uniformly, considering density differences based on an origin of coffee beans, a roasting level, and whether the coffee bean is roasted from green beans or processed beans such as being milled prior to roasting. Such pre-crushing can adjust or ensure consistent flavor of compressed coffee bean blocks. After being processed one or more of the pairs of rollers of the roller section 2110, the coffee beans can be further process by various compression modules which can be switched in and out to provide various crushing forces or impart shapes to the coffee beans to enable a system, device and method for powerful crushing and compression of the coffee beans.

Additionally, as the roller section 2110 that can “pre-crush” can account for adjustments in densities of the coffee bean blocks, applied in tandem with the roller section 2110 can be replaceable or modular compression modules. This allows for more even more control and/consistency in density and shaping of the coffee beans into a desired form or shape of the coffee bean blocks.

The pre-crushing roller is implemented as a roller with adjustable gaps (e.g., adjustable intensity being adjustable with a regulator). This setup can first crush or crack the coffee beans in the roller section 2110 and allow the coffee beans to be later compressed in a compression and discharge unit 4000, such as a pressing section 4600 to further crush the coffee beans, ensuring that the coffee beans receive uniform pressure during compression into coffee bean blocks for optimal results.

The discharge section 2120 can be designed to connect with the internal space of the hopper section 2100 and can be formed as a hollow pipe extending from one end adjacent to the hopper section 2100 to the opposite end. Consequently, the discharge section 2120 can transfer coffee beans to the storage unit 3000 located near the other end.

As shown in FIG. 16, the discharge section 2120 can be eccentrically attached within a center C of an internal space of the hopper section 2100. The discharge section 2120 can be formed as a hollow pipe.

Furthermore, as shown in FIGS. 17 to 19, as long as the hopper section 2100 can transfer coffee beans from the supply area S to the storage unit 3000, the hopper section 2100 can be adapted to various internal arrangement shapes in the main unit 1000. For example, the hopper section 2100 can be designed in a polyhedral shape, a conical shape, or a cylindrical shape, and the discharge section 2120 can be attached to the center C of the internal space of the hopper section 2100, but embodiments of the present disclosure are not limited thereto, and the shape of the hopper section 2100 can be other shapes, and also, the discharge section 2120 can be attached to another location of the internal space of the hopper section 2100 such as a lower side, or at a location away from a center of a bottom of the hopper section 2100, for example.

Additionally, the discharge section 2120 can be made of a flexible hollow pipe that can be eccentrically or centrally attached to the internal space, allowing the discharge section 2120 to change shape or a delivery route to deliver the coffee beans and/or fragments to various positions in the supply area S regardless of the attachment position of the discharge section 2120 with the hopper section 2100.

As described above, the hopper section 2100 can vary from being varying shapes, including a polyhedral shape to a conical shape or a cylindrical shape with a curved outer surface, depending on the positioning of the hopper section 2100 within the main unit 1000, and this still falls within the scope of the invention. For example, the hopper section 2100 can include a conical hopper section 2100-1 or a rectangular hopper section 2100-2, but embodiments of the present disclosure are not limited thereto, and other shapes can be used.

For a more detailed example, the hopper section 2100 of the supply unit 2000 can be embedded within the main unit 1000 to avoid protruding to the outside. In this case, the hopper section 2100 can be polyhedral to fit in compact spaces.

The discharge section 2120 can be arranged eccentrically from the center C of the internal space of the hopper section 2100 depending on the location of the supply area S. The supply unit 2000 can also include a blocking section 2200.

The blocking section 2200 can be designed to cover the hopper section 2100, and can prevent foreign materials other than the coffee beans from entering the hopper section 2100. The blocking section 2200 can be opened on one side, allowing the user to manually input coffee beans into the hopper section 2100. Alternatively or concurrently, an input section 2400 of a conveyor belt-type can be placed inside the blocking section 2200 to automatically supply or input the coffee beans from the outside or a holding bin.

As shown in the figures, when the supply unit 2000 includes both the blocking section 2200 and input section 2400, the supply unit 2000 can further include a displacement sensor section 2500 to monitor whether the coffee beans moving through the input section 2400 pile up above a preset height inside the blocking section 2200. The supply unit 2000 can also include a control and communication section, such as a processor, a control circuit, a CPU, or a computer, that notifies the manager if the coffee beans accumulate beyond the preset height in order to avoid overflow, or to detect any jamming of the roller section 2110 or the discharge section 2120.

Additionally, the supply unit 2000 can include a camera section 2600 for monitoring the inside of the blocking section 2200. The control and communication section can divide the internal space of the blocking section 2200 into multiple compartments or sectors for monitoring purposes and assess the proportion of internal space occupied by coffee beans in each compartment, alerting the manager if there is an operational error, such as a malfunction of any part of the machine, or a jam or piling of the coffee beans.

Additionally, the supply unit 2000 can include a buffer section 2700 that guides coffee beans by using a path with at least a partial curvature toward the hopper section 2100. The buffer section 2700 can prevent or avoid the coffee beans, which are moved by the input section 2400, from colliding with one side of the blocking section 2200 due to inertia or failing to enter the hopper section 2100, which could otherwise cause unwanted damage to the coffee beans, such as creating fragments of undesired sizes that are larger or too smaller than desired.

The storage unit 3000, as described above, can receive the coffee beans in a storage space device 3010 within the supply area S and transport them to the compression area P located on one side of the supply area S. As shown in the figures, the storage unit 3000 can further include a rail section 3200 and a cylinder section 3400.

The rail section 3200 can be formed to extend from the supply area S to the compression area P, establishing the movement path of the storage space device 3010. The cylinder section 3400 is fixed to one side of the rail section 3200 to enable the storage space device 3010 to move back and forth from the supply area S to the compression area P along the rail section 3200 and can be connected to the storage space device 3010.

On one side of the storage space device 3010, a guide stopper 3020 can be formed along the direction of the movement path of the storage space device 3010. The guide stopper 3020 can stabilize the storage space device 3010 when the storage space device 3010 moves towards the compression area P, preventing wobbling when the storage space device 3010 meets the discharge section 2120 of the supply unit 2000. Once the storage space device 3010 is fully moved to the compression area P, the guide stopper 3020 can close off the discharge section 2120 to prevent coffee beans from spilling out.

Inside the storage space device 3010, a pressure plate 3010a can be positioned to lift toward the open surface, and the pressure plate 3010a can be designed to return to its original position when no external force is applied.

Next, details of the compression and discharge unit 4000 as described above will be further discussed.

The compression and discharge unit 4000 compresses and shapes coffee beans in the compression area P and transports the shaped coffee beans BL to the discharge area D on one side of the compression area P for ejection. For instance, the compression and discharge unit 4000 can include a movement section 4200, a position adjustment section 4400, and a pressing section 4600.

The movement section 4200 forms the movement path of a mold device 4010 from the compression area P to the discharge area D. Specifically, the movement section 4200 can be of a length that spans from the compression area P to the discharge area D inside the main unit 1000 and allows the mold device 4010 to slide while in contact with one side.

The position adjustment section 4400 is fixed on one side away from the movement section 4200 and is connected to the mold device 4010, allowing the mold device 4010 to move along the movement section 4200. The pressing section 4600 compresses the inside of the storage space device 3010 within the compression area P, pushing the coffee beans stored in the storage space device 3010 into the mold device 4010 opposite the storage space device 3010.

With this configuration, the compression and discharge unit 4000 positions the mold device 4010 opposite the storage space device 3010 so that the mold device 4010 moves along the open surface of the storage space device 3010, sealing the open surface in the compression area P to compress and shape the coffee beans. This setup allows the movement section 4200, position adjustment section 4400, and pressing section 4600 to be arranged within the main unit 1000. Thus, as illustrated in the figures, the mold device 4010, which holds a mold to form a compressed coffee bean block, can move horizontally along the open surface of the storage space device 3010 from the top of the storage space device 3010 to the discharge area D.

The compression and discharge unit 4000 can minimize interference between the storage space device 3010 and the mold device 4010 by arranging the movement path of the mold device 4010 parallel to the movement path of the storage space device 3010. If a space within the main unit 1000 is limited, the movement path of the mold device 4010 in the compression and discharge unit 4000 can be angled relative to the movement path of the storage space device 3010 in the storage unit 3000.

The mold device 4010 can also be configured to rotate at one end of the position adjustment section 4400 to move along the open surface of the storage space device 3010. The compression and discharge unit 4000 can include multiple unit molding spaces 4020 with different inner shapes, and any one of these unit molding spaces 4020 can be positioned in the compression area P. This setup would still fall within the scope of the invention.

The operation of the compression and discharge unit 4000 in the compression area P is as follows.

The compression and discharge unit 4000 can position the mold device 4010 to face the storage space device 3010 where the coffee beans are stored. In the compression area P, the coffee beans in the storage space device 3010 can be pushed into the mold device 4010 and compressed to form a shaped coffee bean block BL using the aforementioned configurations.

The compression and discharge unit 4000 can include a support plate 4010a within the mold device 4010 to ensure that the pressure applied to the coffee beans is even throughout. For instance, the compression and discharge unit 4000 pushes the coffee beans in the storage space device 3010 upward into the mold device 4010 from below, and the coffee beans are supported by the support plate 4010a, which helps distribute pressure uniformly within the mold device 4010. In various embodiments of the present disclosure, the compression and discharge unit 4000 or components thereof such as mold device 4010 and/or the support plate 4010a can be referred to as a replaceable or modular compression module. Also, the support plate 4010a can be referred to as a flat support plate when a surface thereof is flat.

In various embodiments of the present disclosure, using the pre-crushing roller along with various replaceable or modular compression modules (e.g., pointed shape, flat shape, wavy shape, or branded logo), coffee beans can be compressed with a pressure of over 1,500 kg/cm², ensuring more even compression, but embodiments of the present disclosure are not limited to this pressure. For example, based on an amount of pre-crushing that can occur at the pre-crushing roller, the replaceable or modular compression modules can apply a pressure that is below 1,500 kg/cm², for example, about 500 kg/cm² or less. In various embodiments of the present disclosure, the pressure can be between 100 kg/cm² to 15000 kg/cm², such as between 1,000 kg/cm² to 5000 kg/cm², such as 1,500 kg/cm² to 2,500 kg/cm².

This crushing process with the pressure makes the internal structure of the coffee beans more uniform and finely fragmented, better preserving and expressing the original flavor of the coffee beans.

To cater to the preferences and desired taste profiles of coffee, different compression modules are utilized to adjust compression strength, density, and brand logo imprinting as needed.

In summary, the coffee beans that were initially cracked or first crushed into fragments by the roller section 2110, are subjected to receive uniform pressure between the pressing section 4600 and the flat support plate 4010a, resulting in a second, more refined crushing. This process enhances the flavor of the coffee beans, providing a richer and more authentic taste. Specifically, when the support plate 4010a has a flat supporting surface, the support plate 4010a can be cylindrical, as shown in FIG. 27. The support plate 4010a can also be shaped as a square or rectangular prism and still fall within the scope of the present disclosure, but embodiments of the present disclosure are not limited thereto. The support plate 4010a can have various shapes, such as wavy shape, or square wave shape, or with a plurality of dimples. Sizes of the waves or the dimples can be either the same size or different sizes from an average size of the coffee beans. In various embodiments, the sizes of the waves or the dimples can be smaller than the average sizes of the coffee beans.

In conventional devices with a toothed support plate as illustrated in FIG. 28, the volume difference between areas A1 and A2 in a mold device can result in uneven coffee bean density pressed in areas A1 and A2, and can lead to inconsistent pressure distribution. Additionally, conventional devices lack the roller section 2110 that is provided in the embodiments of the present disclosure, meaning that coffee beans in a molding space of the conventional devices remain uncracked or whole, which can further amplify pressure inconsistencies across areas A1 and A2.

Therefore, in conventional devices with a toothed support plate, coffee beans can be crushed unevenly depending on their placement, with some beans being pressed by pointed areas while others being left intact when wedged between the pointed areas to generate coffee bean blocks of inconsistent internal densities.

In contrast, the compressed coffee bean block manufacturing apparatus in embodiments of the present disclosure, including the roller section 2110 and support plate 4010a, can evenly apply pressure to the coffee beans within the mold device 4010 regardless of position, as illustrated in FIG. 24. This ensures a consistent taste from coffee brewed using the compressed coffee bean block that is discharged from the compressed coffee bean block manufacturing apparatus.

As an alternative, the support plate in the present disclosure can have a curved surface 4010b, as shown with the support plate 4010a-1 that has the curved surface 4010b in FIG. 30. For example, the support plate 4010a-1 can be elongated along its longitudinal axis, with a curved surface 4010b to support the coffee beans.

Specifically, the bean-supporting surface 4010b of the support plate 4010a-1 can be concave towards a center of the support plate 4010a-1, allowing pressure to concentrate toward the center to produce a denser and more firmly shaped compressed coffee bean block BL.

In cases where the compression and discharge unit 4000 compresses and shapes the coffee beans by pushing the coffee beans from the storage space device 3010 into the mold device 4010 in the compression area P, the pressing direction of the compression and discharge unit 4000 can be perpendicular to the direction in which the storage unit 3000 transports the coffee beans to the compression area P. Specifically, the compression and discharge unit 4000 can press the pressure plate 3010a inside the storage space device 3010 in a direction perpendicular to the movement direction of the mold device 4010. This raises the pressure plate 3010a toward the open surface, pushing the coffee beans stored in the storage space device 3010 into the mold device 4010, where they are compressed to form a compressed coffee bean block BL.

The support plate 4010a in the mold device 4010 can be arranged to rise toward the open side of the storage space device 3010, returning to its original position when no external force is applied. The shape of the support plate 4010a can vary, but to ensure uniform pressure on the coffee beans in the mold device 4010, a flat plate or a concave shape that concentrates force toward the center of the compressed coffee bean block can be preferable, but such is not required.

The compression and discharge unit 4000 can also include a separation section 4800 in the discharge area D to separate the shaped coffee beans from the mold device 4010 by pressing on the support plate 4010a. In other words, the compression and discharge unit 4000 can press on the support plate 4010a in the discharge area D, pushing out the shaped coffee beans from the mold device 4010.

Additionally, the compression and discharge unit 4000 can include a removal section 4900 to press the support plate 4010a in the compression area P to remove any remaining coffee bean residues from the mold device 4010.

As described above, the number of times the separation section 4800 or removal section 4900 presses the support plate 4010a can vary, and this variation does not limit the scope of the invention.

For a more detailed example, the separation section 4800 or removal section 4900 can cause the support plate 4010a to reciprocate one to three times per set. Moreover, the device can be configured with only the separation section 4800 or the removal section 4900, allowing either section to move from the discharge area D to the compression area P along with the movement of the mold device 4010.

Next, a detailed description of the unit molding space 4020 within the compression and discharge unit 4000 follows.

The compression and discharge unit 4000 can include multiple unit molding spaces 4020 with different inner shapes. Specifically, the compression and discharge unit 4000 can feature support plates 4010a with various structures, such as honeycomb, grid, or diagonal patterns, allowing for a range of compressed coffee bean block shapes, as shown in the figures.

However, if there is only one mold device 4010, the support plate 4010a can be replaced to achieve the desired coffee bean block shape, which can be inconvenient. Therefore, the compression and discharge unit 4000 can be equipped with multiple unit molding spaces 4020 with different support plate shapes, allowing any unit molding space 4020 with the desired form to be positioned in the compression area P.

For example, a variation of a compression and discharge unit 4000-1 can be circular and have multiple unit molding spaces 4020 with different shapes on a rotating member 4220, allowing any one of these spaces to be positioned in the compression area P as the rotating member 4220 rotates. Each unit molding space 4020 can be equipped with a sensing module to measure the quantity of coffee beans. If the pre-set amount of beans is not filled, the rotating member 4220 will not rotate toward the compression area P but will remain in the supply area S until the required amount is filled, then continue to rotate and move the beans to the compression area P.

Additionally, if the quantity of beans in the unit molding space 4020 falls below the pre-set amount due to centrifugal force or vibrations during rotation or compression, an alarm can notify the user, or the rotating member 4220 can reverse to refill the beans. This arrangement enhances the production speed of compressed coffee bean blocks and helps prevent defects in their formation. In various embodiments of the present disclosure, reference to a coffee bean can include various combination of milled, non-milled, roasted and non-roasted coffee beans, including at least one of a milled coffee bean, a milled and roasted coffee bean, a milled non-roasted (green) coffee bean, a roasted non-milled coffee bean, and a non-milled and non-roasted coffee bean.

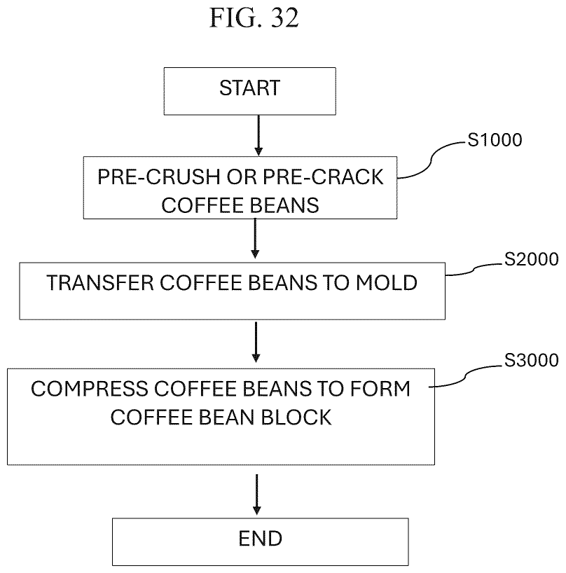

FIG. 32 is a flow diagram of a method of manufacturing a coffee bean block using pre-crushed or pre-cracked coffee beans. As shown in FIG. 32, the method can include a pre-crushing or a pre-cracking operation S1000, a transfer operation S2000 and a coffee bean block forming operation S3000. In various embodiments of the present disclosure, operations S1000, S2000 and S3000 can be performed in the order shown, but embodiments of the present disclosure are not limited thereto. For example, the pre-crushing or the pre-cracking operation S1000 can be performed to produce pre-cracked or fragmented coffee beans, which can be sold without performing the subsequent operations of compressing of the coffee beans and/or making the coffee bean block, or the pre-crushed or pre-cracked coffee beans can be purchased or obtained to perform the operations of compressing the coffee beans and/or making the coffee bean block. Further, the operations of the method need not be performed in close chronological order, but can be performed with gaps in time of over several hours, days or weeks. When performed in chronological order, the pre-crushing or pre-cracking operation S1000 can be performed by the roller section 2110, the transfer operation S2000 can be performed by the storage unit 3000 or its various components, and the coffee bean block forming operation S3000 can be performed by the compression and discharge unit 4000 or its various components, but embodiments of the present disclosure are not limited thereto. Additional pre-processing, such as milling as disclosed in FIG. 9, can be included in the method of a method of manufacturing a coffee bean block using pre-crushed or pre-cracked coffee beans of the embodiment of the present disclosure.

Also, as shown in Table 2, below, and comparing various flavonoids such as glutamic acid, proline, alanine, leucine and phenylalanine, those of coffee made from compressed coffee blocks that are pre-cracked and compressed have greater amount than coffee made from coffee blocks that are compressed only. Accordingly, the amounts of flavonoids in coffee from compressed coffee blocks that are formed by pre-cracking and compression of the coffee beans are greater than coffee from compressed coffee blocks that are formed by compression only of the coffee beans.

TABLE 2

| | | | | Result |
|---|---|---|---|---|
| | | | Result | (pre-cracked |
| | | | (compressed | and |
| Item | Unit | Method | only) | compressed) |
| Glutamic acid | mg/100 g | Amino acid | 33.58 | 47.45 |
| | | Analyzer | | |
| Proline | mg/100 g | Amino acid | 5.65 | 7.96 |
| | | Analyzer | | |
| Alanine | mg/100 g | Amino acid | 4.29 | 6.24 |
| | | Analyzer | | |
| Leucine | mg/100 g | Amino acid | 7.08 | 10.85 |
| | | Analyzer | | |
| Phenylalanine | mg/100 g | Amino acid | 4.95 | 7.51 |
| | | Analyzer | | |

Although the example embodiments of the present disclosure have been described in detail with reference to the accompanying drawings, the present disclosure is not limited thereto and can be embodied in many different forms without departing from the technical concept of the present disclosure. Therefore, the example embodiments of the present disclosure are provided for illustrative purposes only but not intended to limit the technical concept of the present disclosure. Therefore, it should be understood that the above-described example embodiments are illustrative in all aspects and do not limit the present disclosure. The protective scope of the present disclosure should be construed based on the following claims, and all the technical concepts in the equivalent scope thereof should be construed as falling within the scope of the present disclosure.

1. A compressed coffee bean block manufacturing apparatus comprising:
a main unit;
a supply unit that provides coffee beans to a supply area located within the main unit;
a storage unit that receives the coffee beans in a storage space device from the supply area and transports the coffee beans to a compression area on one side of the supply area; and
a compression and discharge unit that compresses and shapes the coffee beans in the compression area into a coffee bean block and then transports the coffee bean block to a discharge area on one side of the compression area for ejection,
wherein the supply unit is configured to compress or crack the coffee beans before providing the coffee beans to the supply area,
wherein the supply unit comprises:
a hopper section with an internal space;
a roller section including a pair of rollers and arranged within the hopper section to compress or crack the coffee beans; and
a discharge section configured to communicate with the internal space of the hopper section,
wherein the roller section is configured to operate in an engaged mode and a bypass mode, and
wherein, in the engaged mode of the roller section, the pair of rollers of the roller section are separated by a gap that is about 50% to 95% of an average size of one or more of the coffee beans to compress or crack the coffee beans, and in the bypass mode, the pair of rollers are separated by a gap that is about 100% to about 1000% of an average size of one or more of the coffee beans to allow free passage of the coffee beans without compressing or cracking the coffee beans.

2. (canceled)

3. The apparatus of claim 1, wherein the roller section comprises a plurality of pairs of unit rollers within the hopper section, the plurality of pairs of unit rollers being arranged in series in a direction toward the discharge section.

4. The apparatus of claim 1, wherein the discharge section is eccentrically attached to a center of the internal space of the hopper section.

5. (canceled)

6. (canceled)

7. The apparatus of claim 1, wherein the compression and discharge unit comprises a molding device configured to compress the coffee beans, the molding device being positioned opposite the storage space device, and
wherein the molding device pushes the coffee beans in the storage space device into a molding space to compress and shape the coffee beans into the coffee bean block.

8. The apparatus of claim 7, wherein the compression and discharge unit includes a support plate in the molding device to apply uniform pressure to the coffee beans.

9. The apparatus of claim 7, wherein the compression and discharge unit presses the coffee beans in a direction perpendicular to a transportation direction of the storage unit to the compression area.

10. The apparatus of claim 7, wherein the molding device opposite the storage space device moves along an open surface of the storage space device, and seals the storage space device in the compression area to compress and shape the coffee beans into the coffee bean block.

11. The apparatus of claim 10, wherein the molding device containing the coffee bean block moves horizontally along the open surface of the storage space device to the discharge area.

12. The apparatus of claim 11, wherein a movement path of the molding device is parallel to a movement path of the storage space device.

13. The apparatus of claim 10, wherein the compression and discharge unit includes a plurality of unit molding spaces with an internal shape, and at least one of the plurality of unit molding devices is positioned in the compression area.

14. The apparatus of claim 7, wherein the compression and discharge unit further comprises:
a movement section forming a path of the molding device from the compression area to the discharge area;
a position adjustment section fixed on one side and connected to the molding device on another side to allow movement of the molding device; and
a pressing section that pushes the coffee beans in the storage space device into the molding device opposite to the storage space device in the compression area.

15. The apparatus of claim 14, wherein the compression and discharge unit further includes a separation section to separate the coffee bean block in the discharge area.

16. The apparatus of claim 1, wherein the storage unit comprises:
a rail section to form a movement path of the storage space device; and
a cylinder section fixed to one side of the rail section, allowing the storage space device to move back and forth along the rail section from the supply area to the compression area.

17. The apparatus of claim 1, wherein an amount of acrylamide in coffee from the coffee bean block formed by the apparatus is less than about 17.21 μg/kg.

18. The apparatus of claim 1, wherein the compression and discharge unit applies a pressure between about 1,000 kg/cm² to 5000 kg/cm² to the coffee beans in the compression area to compress and shape the coffee beans into the coffee bean block.

19. The apparatus of claim 18, wherein the pressure is about 1,500 kg/cm.

20. The apparatus of claim 1, wherein, in coffee from the coffee bean block formed by the apparatus, an amount of glutamic acid present is about 47.45 mg/100 g, an amount of proline present is about 7.96 mg/100 g, an amount of alanine present is about 6.24 mg/100 g, an amount of leucine present is about 10.85 mg/100 g and an amount of phenylalanine present is about 7.51 mg/100 g.

21. The apparatus of claim 1, wherein the compression and discharge unit includes a circular body that rotates, and a plurality of unit molding spaces are arranged at a periphery of the circular body at regular intervals.

22. The apparatus of claim 16, wherein the storage space device includes a pressure plate within the storage space device and the pressure plate is configured to move upward in a vertical direction, and
wherein the storage space device is configured to move horizontally back and forth by the cylinder section.
